(19) United States
(12) Patent Application Publication
(10) Pub. No.: US 2014/0237251 A1
(43) Pub. Date: Aug. 21, 2014

(54) Digital Signature System

(71) Applicant: Cisco Technology Inc., San Jose, CA (US)

(72) Inventors: Uri KALUZHNY, Ramat Beit Shemesh (IL); Anna SCHNAIDERMAN, Jerusalem (IL)

(21) Appl. No.: 13/956,991

(22) Filed: Aug. 1, 2013

(30) Foreign Application Priority Data
Feb. 21, 2013 (IL) 224890

(51) Int. Cl. H04L 29/06

(52) U.S. Cl. CPC H04L 63/0428
USPC 713/176

(57) ABSTRACT

A message signing system including a processor operative to receive a seed S₀ and a number N from an authority providing permission to digitally sign up to N messages for a client device, successively apply a one-way function to the seed S₀ yielding a chain having a plurality of values Sᵢ, i being greater than zero, create up to N digital signatures, creation of each digital signature including evaluating an encryption function with one of the values Sᵢ and a MAC of one of the messages as input to the encryption function, the MAC being a keyed hash function, each of the created digital signatures being based on a different one of the values Sᵢ and a different one of the messages, and send the created digital signatures and the messages signed by the created digital signatures to the client device. Related apparatus and methods are also included.

### RELATED APPLICATION INFORMATION

The present application claims priority from Israel Patent Application No. 224,890 filed 21 Feb. 2013.

### FIELD OF THE INVENTION

The present invention relates to digital signatures and, in particular, to a digital signature system with limited signing authority.

### BACKGROUND OF THE INVENTION

The following references are believed to represent the state of the art:

U.S. Pat. No. 5,131,039 to Chaum;

U.S. Pat. No. 5,245,657 to Sakurai;

U.S. Pat. No. 5,519,778 to Leighton, et al.;

U.S. Pat. No. 5,774,550 to Brinkmeyer, et al.;

U.S. Pat. No. 5,960,083 to Micali;

U.S. Pat. No. 6,363,149 to Candelore;

U.S. Pat. No. 6,603,857 to Batten-Carew, et al.;

U.S. Pat. No. 8,171,524 to Macali, et al.;

PCT Published Patent Application WO 97/045817 of De Jong, et al.;

PCT Published Patent Application WO 02/050631 of Singlesignon.net;

EP Published Patent Application EP 2247106 of Sony Electronics Inc; and

Password Authentication with Insecure Communication, Leslie Lamport, SRI International, Communication of the ACM, Nov. 1981, Vol. 24, No. 11.

### BRIEF DESCRIPTION OF THE DRAWINGS

The present invention will be understood and appreciated more fully from the following detailed description, taken in conjunction with the drawings in which:

FIG. 1 is a partly pictorial, partly block diagram view of a messaging system constructed and operative in accordance with an embodiment of the present invention;

FIG. 2 is a view of a chain of values for use in the system of FIG. 1;

FIG. 3 is a partly pictorial, partly block diagram view of an authority in the system of FIG. 1 sending permissions to a message signing system and a client device;

FIG. 4 is a partly pictorial, partly block diagram view of the message signing system of FIG. 3 receiving and processing the permissions;

FIG. 5 is a partly pictorial, partly block diagram view of preparation and authentication of a signature in the system of FIG. 1;

FIG. 6 is a partly pictorial, partly block diagram view of preparation and authentication of another signature in the system of FIG. 1;

FIG. 7 is partly pictorial, partly block diagram view of an alternative method of authentication of the signature of FIG. 6;

FIG. 8 is a partly pictorial, partly block diagram view of preparation and authentication of yet another signature in the system of FIG. 1;

FIG. 9 is partly pictorial, partly block diagram view of preparation and authentication of a signature using AES in the system of FIG. 1;

FIG. 10 is partly pictorial, partly block diagram view of preparation and authentication of a signature using XOR in the system of FIG. 1;

FIG. 11 is a flow chart showing steps included in the preparation of signatures in the system of FIG. 1;

FIG. 12 is a flow chart showing steps included in the authentication of signatures in the system of FIGS. 1; and

FIG. 13 is a block diagram of the message signing system and one of the client devices in the system of FIG. 1.

### DETAILED DESCRIPTION OF AN EMBODIMENT

The term “encoded” is used throughout the present specification and claims, in all of its grammatical forms, to refer to any type of data stream encoding including, for example and without limiting the scope of the definition, well known types of encoding such as, but not limited to, MPEG-2 encoding, H.264 encoding, VC-1 encoding, and synthetic encodings such as Scalable Vector Graphics (SVG) and LASER (ISO/IEC 14496-20), and so forth. It is appreciated that an encoded data stream generally requires more processing and typically more time to read than a data stream which is not encoded. Any recipient of encoded data, whether or not the recipient of the encoded data is the intended recipient, is, at least in potential, able to read encoded data without requiring cryptanalysis. It is appreciated that encoding may be performed in several stages and may include a number of different processes, including, but not necessarily limited to: compressing the data; transforming the data into other forms; and making the data more robust (for instance replicating the data or using error correction mechanisms).

The term “compressed” is used throughout the present specification and claims, in all of its grammatical forms, to refer to any type of data stream compression. Compression is typically a part of encoding and may include image compression and motion compensation. Typically, compression of data reduces the number of bits comprising the data. In that compression is a subset of encoding, the terms “encoded” and “compressed”, in all of their grammatical forms, are often used interchangeably throughout the present specification and claims.

Similarly, the terms “decoded” and “decompressed” are used throughout the present specification and claims, in all their grammatical forms, to refer to the reverse of “encoded” and “compressed” in all their grammatical forms.

The terms “scrambled” and “encrypted”, in all of their grammatical forms, are used interchangeably throughout the present specification and claims to refer to any appropriate scrambling and/or encryption methods for scrambling and/or encrypting a data stream, and/or any other appropriate method for intending to make a data stream unintelligible except to an intended recipient(s) thereof. Well known types of scrambling or encrypting include, but are not limited to DES, 3DES, and AES. Similarly, the terms “descrambled” and “decrypted” are used throughout the present specification and claims, in all their grammatical forms, to refer to the reverse of “scrambled” and “encrypted” in all their grammatical forms.

Pursuant to the above definitions, the terms “encoded”; “compressed”; and the terms “scrambled” and “encrypted” are used to refer to different and exclusive types of processing. Thus, a particular data stream may be, for example:

encoded, but neither scrambled nor encrypted;

compressed, but neither scrambled nor encrypted;

scrambled or encrypted, but not encoded;

scrambled or encrypted, but not compressed;

encoded, and scrambled or encrypted; or

compressed, and scrambled or encrypted.

Likewise, the terms “decoded” and “decompressed” on the one hand, and the terms “descrambled” and “decrypted” on the other hand, are used to refer to different and exclusive types of processing.

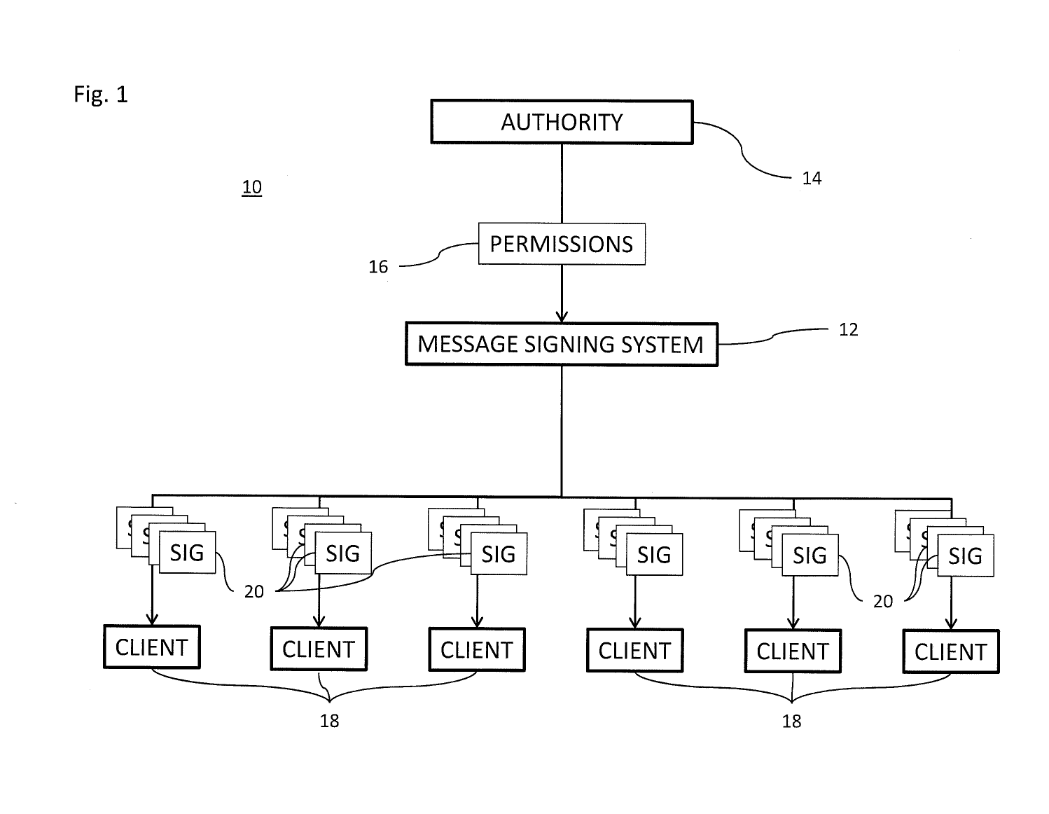

Reference is now made to FIG. 1, which is a partly pictorial, partly block diagram view of a messaging system 10 constructed and operative in accordance with an embodiment of the present invention.

The messaging system 10 generally provides security in a situation where a message signing system 12 cannot be fully trusted, for example, but not limited to, a local broadcaster in a pay TV environment where the local broadcaster does not have suitable conditions to keep the secrets safely or is suspected to misuse the secrets or any other suitable reason, for example, but not limited to, where the message signing system 12 is granted signing rights paid for on a per signature basis. In these, or similar situations, an authority 14 (for example, a conditional access provider) may be unwilling to make the message signing system 12 an autonomous security system but rather arranges the operation of the message signing system 12 to be dependent on regular input from the authority 14.

The messaging system 10 is built on a model of “rationed” security, whereby the authority 14 provides permissions 16 to the message signing system 12 to sign up to N messages resulting in N signatures 20 (only some labeled in FIG. 1 for the sake of simplicity) for a plurality of clients 18 of the message signing system 12.

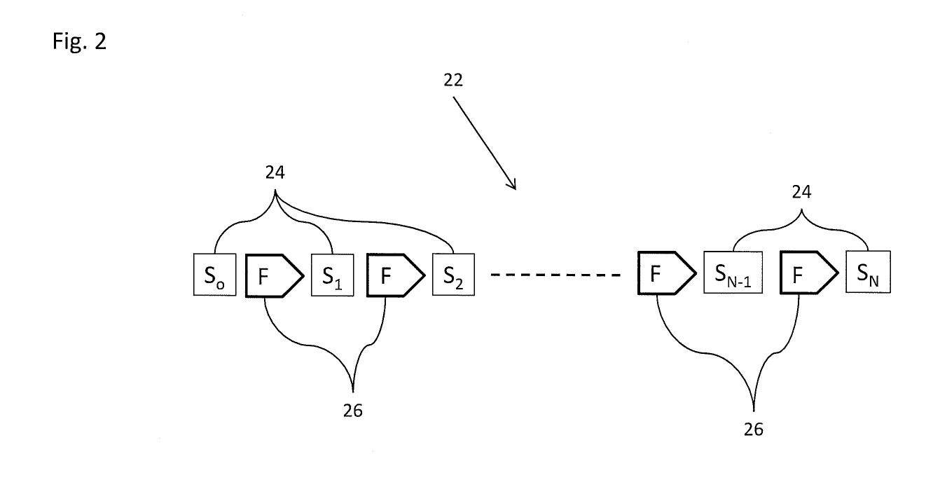

Reference is now made to FIG. 2, which is a view of a chain 22 of values 24 for use in the system 10 of FIG. 1.

The authority 14 (FIG. 1) typically selects a random or pseudo-random seed S₀. The authority 14 then successively applies a one-way function F (blocks 26) to the seed S₀, N times, yielding the chain 22 having a plurality of values Sᵢ (blocks 24) including S_{N}, i having values from 1 to N inclusive. The term “successively applying” used in the specification and claims is defined herein to include evaluating the one-way function F (block 26) with an input value yielding an output value which then becomes the input value for the next application of the one-way function F (block 26) and so on.

The one-way function (block 26) is a function that is practically computable in the forward direction (from input to output) but infeasible to calculate in the inverse direction (from output to input). For the purposes of the present application, the term one-way function as used in the specification and claims is defined as a mathematical function which is at least 2⁴⁰ times quicker to compute in the forward direction than in the inverse direction. Any suitable one-way function may be used, for example, but not limited to, a cryptographic hash function, such as SHA-1 or MD5.

The one-way function may also be implemented in other suitable ways for example, using a block cipher with AES. A first option is to encrypt Sᵢ and then perform an exclusive-OR operation with the output of the encryption operation and the encryption input Sᵢ. A second option is to encrypt a constant value (for example, but not limited to, zero) with Sᵢ as the encryption key. A third option is to encrypt a constant value (for example, but not limited to, zero) with the input Sᵢ as the encryption key and then perform an exclusive-OR operation with the output of the encryption operation and the input Sᵢ. It will be appreciated by those ordinarily skilled in the art that there are numerous suitable ways to build a one-way function from a block cipher.

For different client devices 18 (FIG. 1), different one way functions may be used whereby the function output is dependent upon a parameter which is unique for a particular device 18 (FIG. 1). Different one way functions may be implemented by using a device specific parameter which is concatenated with the value Sᵢ and then inputted into the one-way function F. Alternatively, the device specific parameter may form the basis of an encryption key used in the one-way function F.

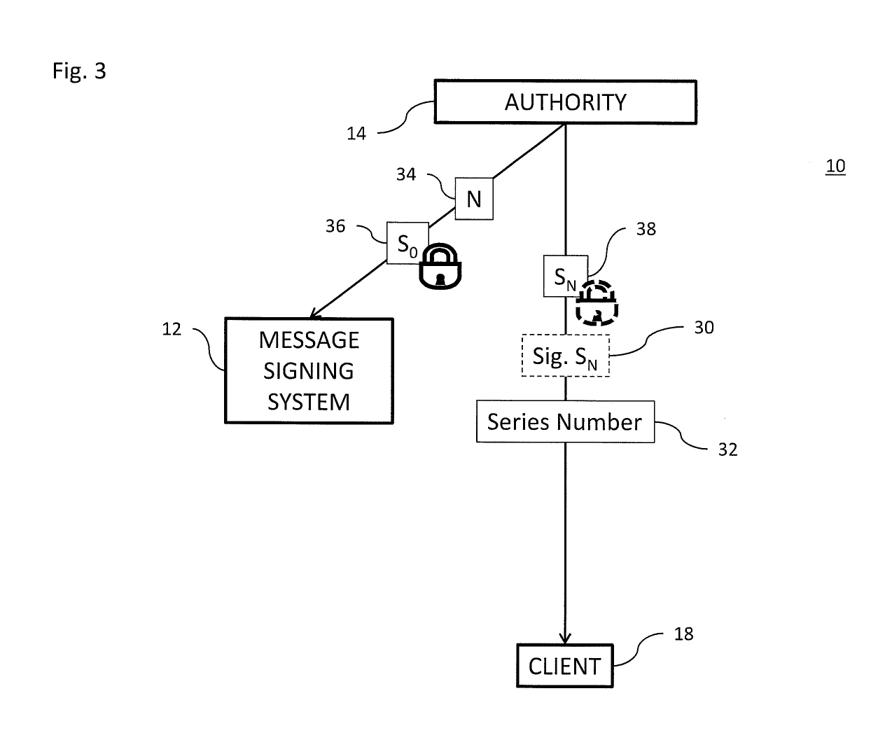

Reference is now made to FIG. 3, which is a partly pictorial, partly block diagram view of the authority 14 in the system 10 of FIG. 1 sending permissions to the message signing system 12 and the client device 18.

The authority 14 typically sends permissions to all the clients 18, as appropriate in order to provide a limit as to the number of times the message signing system 12 is allowed to sign messages for receipt by the client devices 18. FIG. 3 only shows one client device 18 for the sake of clarity.

The permissions sent by the authority 14 to the message signing system 12 typically include N (block 34) and S₀ (block 36), N (block 34) being the number of signatures authorized by the authority 14 that the message signing system 12 can sign for the client devices 18 based on the series of the values 24 (FIG. 2) starting with the seed S₀ (block 36). The seed S₀ (block 36) sent by the authority 14 to the message signing system 12 is typically encrypted by the authority 14 for decryption by the message signing system 12 using any suitable encryption method for example, but not limited to, symmetric encryption based on a shared secret key and/or public key cryptographic techniques.

The permissions sent by the authority 14 to the client devices 18 typically include a series number 32 and the value S_{N} (block 38) also known as a “security field”. The value S_{N} (block 38) and/or the series number sent by the authority 14 to the client devices 18 may be signed using a digital signature 30 and/or encrypted by the authority 14 for decryption by the client devices 18 using any suitable encryption method for example, but not limited to, symmetric encryption based on a shared key and/or public key cryptographic techniques. The value S_{N} (block 38) and the series number may be signed and/or encrypted separately or as a combined value. If the value S_{N} (block 38) and/or the series number are signed, then the digital signature(s) 30 will also be sent by the authority 14 to the client device 18 along with the value S_{N} (block 38) and the series number 32. The series number 32 is to identify a new series of the values 24 (FIG. 2) starting with the seed S₀ (block 36). After the client device 18 receives the series number and checks the digital signature 30 (if used), the client device 18 verifies that the currently received series number has increased with respect to the series number of the previously received series in order to prevent a replay attack.

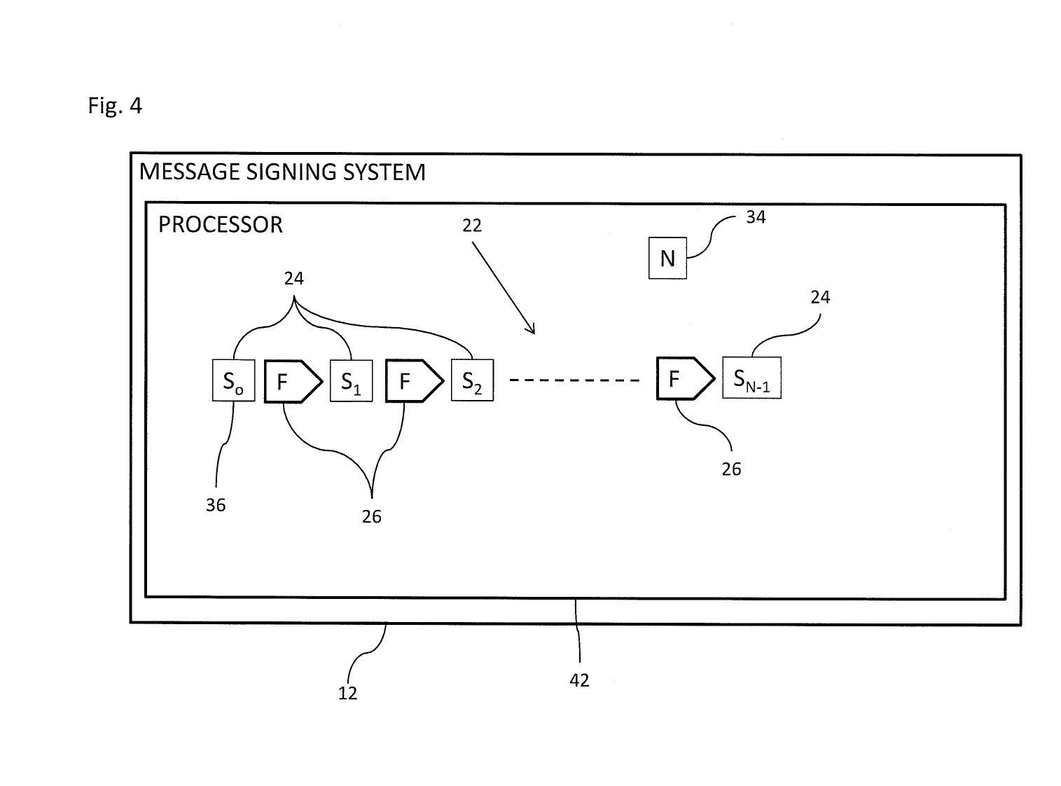

Reference is now made to FIG. 4, which is a partly pictorial, partly block diagram view of the message signing system 12 of FIG. 3 receiving and processing the permissions.

The message signing system 12 typically includes a processor 42.

The processor 42 is typically operative to receive the seed S₀ (block 36) and the number N (block 34) from the authority 14 (FIG. 3) providing permission to digitally sign up to N messages for the client device 18 (FIG. 3). The seed S₀ (block 36) is typically received from the authority 14 (FIG. 3) in an encrypted format as described above with reference to FIG. 3.

The processor 42 is typically operative to decrypt the encrypted seed S₀ (block 36) yielding a decrypted version of the seed S₀ (block 36) for input into the one-way function F (block 26).

As the one-way function F (block 26) is known to the message signing system 12, the message signing system 12 can calculate the values 24 from S₁ and onwards using the one-way function F (block 26).

The processor 42 is typically operative to successively apply the one-way function F (block 26) to the seed S₀ (block 36) yielding the chain 22 having a plurality of values Sⱼ, j having values from 1 to N-1 inclusive. S₁ is the result of applying the one-way function once to the seed S₀. For values of j greater than 1, the value Sⱼ is the result of successively applying the one-way function to the seed S₀ j times. FIG. 4 shows that the one-way function F (block 26) has been successively applied N-1 times to the seed S₀ (bloc 36) yielding the value S_{N-1}.

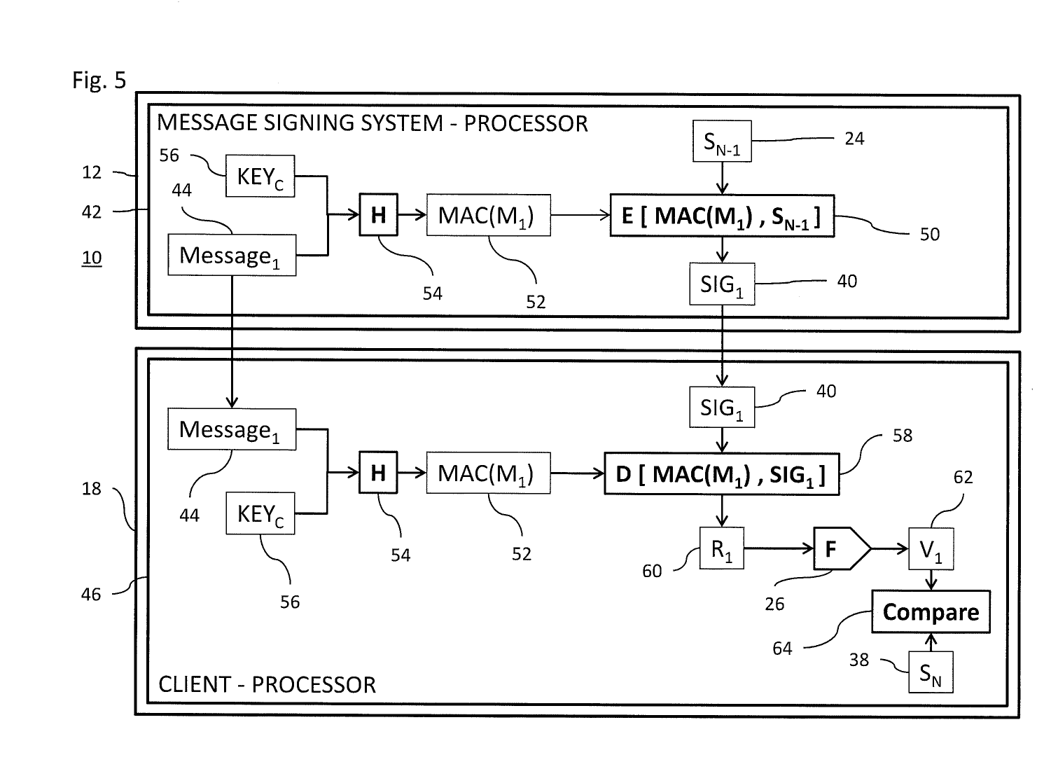

Reference is now made to FIG. 5, which is a partly pictorial, partly block diagram view of preparation and authentication of a signature 40 in the messaging system 10 of FIG. 1.

The processor 42 of the message signing system 12 is typically operative to create up to N digital signatures 40 (SIGᵢ) (only one shown in FIG. 5) for up to N corresponding messages 44 (Mᵢ) (only one shown in FIG. 5), i having values from 1 to N, inclusive.

Creation of each digital signature 40 by the processor 42 includes evaluating an encryption function E (block 50) with one of the values Sⱼ (block 24 of FIG. 4) and a MAC (block 52) of one of the messages 44 as input to the encryption function E (block 50). Each created digital signature 40 is generally based on a different one of the values 24 (Sⱼ) and a different one of the messages 44.

FIG. 5 shows the creation of a first one of the signatures 40 (labeled SIG₁) for a first one of the messages 44 (labeled Message₁) based on evaluating the encryption function E (block 50) with the MAC of M₁ (block 52) and the value 5_{N-1} (block 24) as input.

The creation of SIG₁ may be expressed mathematically as follows:

SIG₁=E(MAC(M₁),S_{N-1}).

The value S_{N-1} (block 24) may be determined by the message signing system 12 successively applying the one-way function F to the seed S₀ N-1 times, as described above with reference to FIG. 4.

The MAC (block 52) of the message 44 is typically produced by a MAC function 54. The MAC function 54 is typically a keyed hash function where a key 56 of the MAC function 54 is a secret shared by the message signing system 12 and the client device 18. The relevant message 44 and the key 56 are the inputs to the MAC function 54. Each client device 18 will typically have a different secret key 56 which is shared with the message signing system 12 for use in applying the MAC function 54. The MAC function 54 may be one of the common mechanisms used for symmetric signatures, for example HMAC-SHA256, HMAC-MD5 or AES CBC-MAC. The shared secret key 56 may be shared between the message signing system 12 and the client device 18 at production time or at some later time for example, the shared secret key 56 may be sent from the authority 14 to the message signing system 12 and the client device 18 in an encrypted format or via a secure channel.

The function E (block 50) may be any suitable encryption function, for example XOR or AES encrypting the value S_{N-1} with MAC(M₁) (block 52) as the encryption key. So for SIG₁, an XOR encryption function typically evaluates MAC(M₁) XOR S_{N-1} AES encrypting the value S_{N-1}with MAC(M₁) (block 52) as the encryption key may be represented as AES_{ENC MAC(M)} S_{N-1}.

The processor 42 is typically operative to send the created digital signature(s) 40 and the message(s) 44 signed by the created digital signatures 40 to the client device 18. FIG. 5 shows the message signing system 12 sending Message and SIG₁ to the client device 18.

The client device 18 typically includes a processor 46.

The processor 46 is typically operative to receive the security field S_{N} (block 38) from the authority 14 (FIG. 3). The processor 46 is typically operative to decrypt the security field S_{N} (block 38), if the security field S_{N} (block 38) was received in an encrypted format from the authority 14. If the security field S_{N} (block 38) was signed with the digital signature 30 (FIG. 3), then the digital signature 30 will be checked.

The processor 46 is typically operative to receive up to N messages 44 (only one shown in FIG. 5) and up to N digital signatures 40 (only one shown in FIG. 5) from the message signing system 12. Each digital signature 40 signs a different message 44.

The processor 46 is typically operative to authenticate Message₁ (block 44) against SIG₁ (block 40) which signs Message₁ (block 44).

The authentication typically includes several steps as follows.

First, a decryption function D (block 58) is evaluated with SIG₁ (block 40) and the MAC (block 52) of the Message₁ (block 44) as input to the decryption function D (block 58) yielding a result R₁ (block 60).

The determination of result R₁ (block 60) may be expressed mathematically as follows: R₁=D (MAC(M₁), SIG₁). The decryption function D (block 58) may be any suitable decryption function, for example XOR or AES decrypting SIG₁ with MAC(M₁) (block 52) as the decryption key, so for SIG₁ the decryption function D (block 58) may evaluate SIG₁ XOR S_{N-1} or AES_{ENC} SIG₁, by way of example only.

It will be appreciated that if SIG₁ (block 40) in fact authenticates Message₁ (block 44) then R₁ (block 60) will be equal to the value S_{N-1} (block 24) as the decryption function D (block 58) is the decryption function which corresponds to the encryption function E (block 50) such that a value encrypted by the encryption function E (block 50) may be decrypted by the decryption function D (block 58) yielding the same value that was originally encrypted by the encryption function E (block 50).

Therefore, as the client device 18 was only sent the value S_{N} (block 38) by the authority 14 (FIG. 3) and the value S_{N-1} (block 24) cannot be determined (or cannot easily be determined) from the value S_{N} (block 38), the one-way function F (block 26) is applied to the result R₁ (block 60) yielding a value V₁ (block 62) which should equal the value S_{N} (block 38) if SIG₁ (block 40) in fact authenticates Message₁ (block 44).

Therefore, the final step (block 64) in authentication is to check if the value V₁ (block 62) is equal to the security field S_{N} (block 38). If the value V₁ (block 62) is equal to the security field S_{N} (block 38) then it has been confirmed that SIG₁ signs Message₁ and that Message is authentic.

Reference is again made to FIG. 4.

Based on the above authorization of SIG₁ (FIG. 5), the client device 18 (FIG. 5) now knows the value S_{N-1} (block 24) thereby making the use of the value S_{N-1} (block 24) in future signature preparation by the message signing system 12 undesirable for security reasons. Therefore, the next digital signature prepared by the message signing system 12 for the client device 18 (FIG. 5) needs to use the value S_{N-2} or any other value 24 closer to the seed S₀ (block 36) along the chain 22. Obviously it is desirable to use S_{N-2} in order to maximize the number of signatures authorized for signing by the authority 14 (FIG. 3). So in the above manner the message signing system 12 can use each of the values 24 in the chain 22 for signing a different one of the messages 44 (FIG. 5) so that the signing authority issued by the authority 14 (FIG. 3) to the message signing system 12 is limited to signing N messages. It will be appreciated that if the values 24 are used in sequential order from S_{N-1} to S₀ (block 36), then the message signing system 12 will be able to sign N messages. It will also be appreciated that due to the nature of the one-way function F (block 26), the message signing system 12 cannot easily calculate values in the chain 22 prior to S₀ (block 36). So in general, the processor 42 (FIG. 5) is operative such that successively sent digital signatures 40 are based on the values 24 (FIG. 4) of the chain 22 (FIG. 4) which are successively closer to the seed S₀ (block 36). However, if the message signing system 12 decides to skip one or more of the values 24 in the chain 22, then the number of signatures will be reduced to below N.

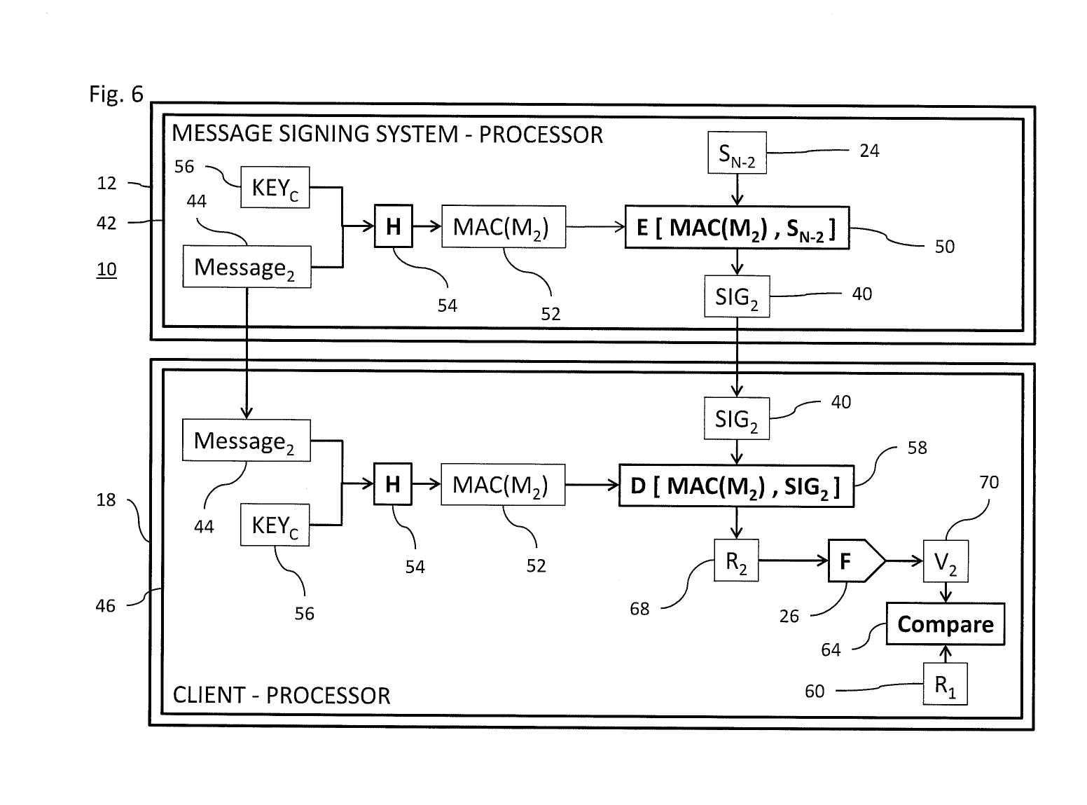

Reference is now made to FIG. 6, which is a partly pictorial, partly block diagram view of preparation and authentication of another signature 40 in the system 10 of FIG. 1.

FIG. 6 shows the preparation of a digital signature SIG₂ (block 40) for Message₂ (block 44) by the processor 42 of the message signing system 12. The preparation of SIG₂ is substantially the same as the preparation of SIG₁ of FIG. 5 except that the inputs to the encryption function E (block 50) are MAC(M₂) (block 52) and S_{N-2} (block 24) where MAC(M₂) (block 52) is based on the key 56 and Message₂ (block 44) as input to the MAC function 54.

The processor 46 of the client device 18 is typically operative to authenticate Message₂ (block 44) against SIG₂ (block 40) which signs Message₂ (block 44).

The authentication typically includes several steps as follows.

First, the decryption function D (block 58) is evaluated with SIG₂ (block 40) and the MAC (block 52) of the Message₂ (block 44) as input to the decryption function D (block 58) yielding a result R₂ (block 68).

The determination of result R₂ (block 68) may be expressed mathematically as follows: R₂=D (MAC(M₂), SIG₂).

It will be appreciated that if SIG₂ (block 40) in fact authenticates Message₂ (block 44) then R₂ (block 68) will be equal to the value S_{N-2} (block 24). The one-way function F (block 26) is applied to the result R₂ (block 68) yielding a value V₂ (block 70) which should equal the value S_{N-1} which is the same as R₁ (block 60) if SIG₂ (block 40) in fact authenticates Message₂ (block 44).

Typically, the next step (block 64) in authentication is to check if the value V₂ (block 70) is equal to R₁ (block 60). If the value V₂ (block 70) is equal to R₁ (block 60) then it has been confirmed that SIG₂ signs Message₂ (block 44) and that Message₂ (block 44) is authentic.

It will be appreciated that the above steps performed by the processor 46 implicitly check that the value V₂ (block 70) is closer to the seed S₀ (block 36 in FIG. 4) along the chain 22 (FIG. 4) than the value V₁ (block 62 in FIG. 5).

It will be appreciated that the messaging system 10 provides a two-layered signature mechanism. The first layer is a digital signature in the form of the MAC (block 52) of the message (block 44) to protect against a forgery by an external attacker. The second layer involves using of one of the values 24 (FIG. 4) in the chain 22 (FIG. 4) to provide cryptographic protection on the number of digital signatures that can be created by the message signing system 12.

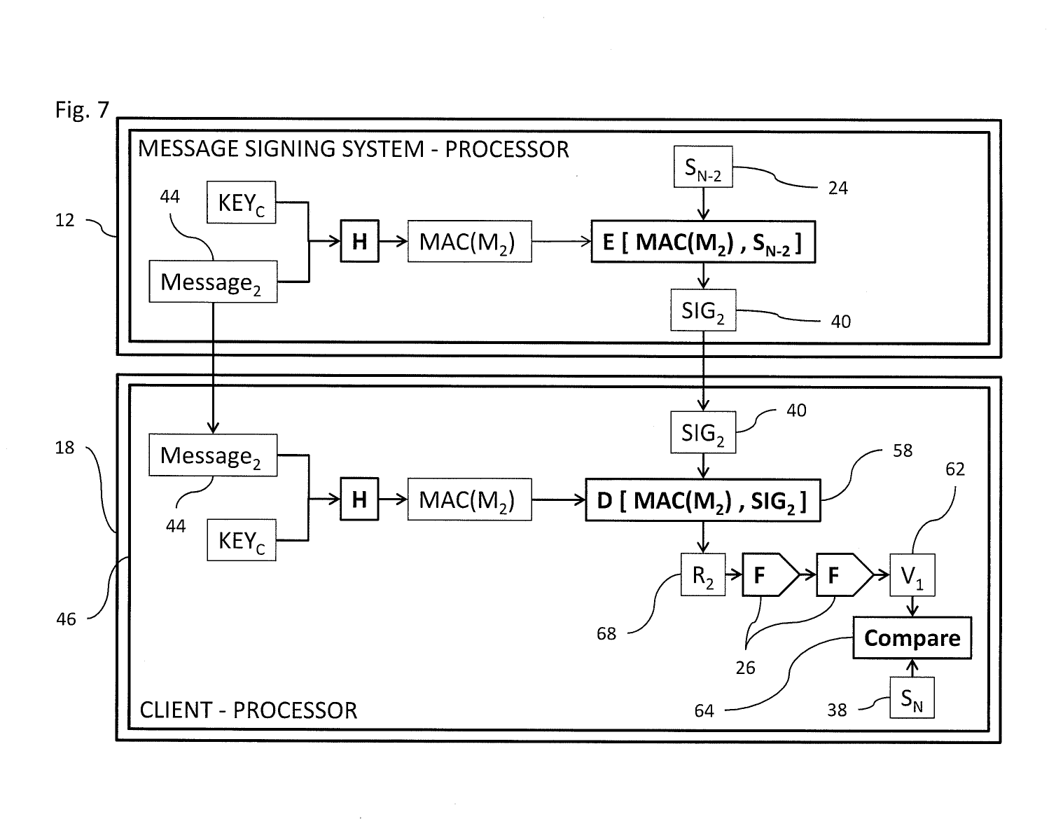

Reference is now made to FIG. 7, which is partly pictorial, partly block diagram view of an alternative method of authentication of the signature 40 (SIG₂) of FIG. 6.

In the authentication method of FIG. 6, the one-way function F (block 26) is applied to the result R₂ (block 68) yielding the value V₂ (block 70 in FIG. 6) which should equal the value S_{N-1} which is the same as R₁ (block 60 in FIG. 6) if SIG₂ (block 40) in fact authenticates Message₂ (block 44).

In the authentication method of FIG. 7, the one-way function F (block 26) is applied to the result R₂ (block 68) successively a number of times (twice in the example of FIG. 7) yielding the value V₁ (block 62) which should equal the value S_{N} (block 38) if SIG₂ (block 40) in fact authenticates Message₂ (block 44). Therefore, the next authentication step (block 64) is to check if the value V₁ (block 62) is equal to the security field S_{N} (block 38). If the value V₁ (block 62) is equal to the security field S_{N} (block 38) then it has been confirmed that SIG₂ signs Message₂ and that Message₂ is authentic.

The above authentication method including applying the one-way function F (block 26) to the result (block 68) of the decryption operation (block 58) successively may be performed for many reasons. First, it may be performed as standard procedure whereby all signatures are checked by successively applying the one-way function F (block 26) to the result (block 68) of the decryption operation (block 58) until the value S_{N} (block 38) or any other value 24 in the chain 22 (FIG. 4) known to the client device 18 is outputted by the one-way function F (block 26). Second, it may be performed when the client device 18 did not receive one or more previous signatures (e.g. SIG₁) and therefore the client device 18 does not know the correct value 24 (e.g.: S_{N-1} in the case of FIG. 7) for comparing to V₂ (block 70 in FIG. 6). Third, it may be performed when the message signing system 12 skipped one or more of the values 24 (FIG. 4) in the chain 22 (FIG. 4) (for example, when SIG₂ is the first digital signature prepared by the message signing system 12 based on the value S_{N-2} (block 24)) and therefore the client device 18 does not know the correct value 24 (e.g.: S_{N-1} in the case of FIG. 7) for comparing to V₂ (block 70 in FIG. 6).

It may be necessary for the processor 46 to check that the result (block 68) of the decryption operation (block 58) is closer to the seed S₀ (block 36 in FIG. 4) along the chain 22 (FIG. 4) than the result (block 68) of the decryption operation (block 58) for the previous signature received or to check that the number of times the one-way function F (block 26) is repeated to reach S_{N} (block 38) is greater for the current signature than for the previous signature. This is performed for security reasons because if the value 24 used to sign the message is not closer to the seed S₀ (block 36 in FIG. 4) then the current signature may have been compromised, as discussed above with reference to FIG. 5.

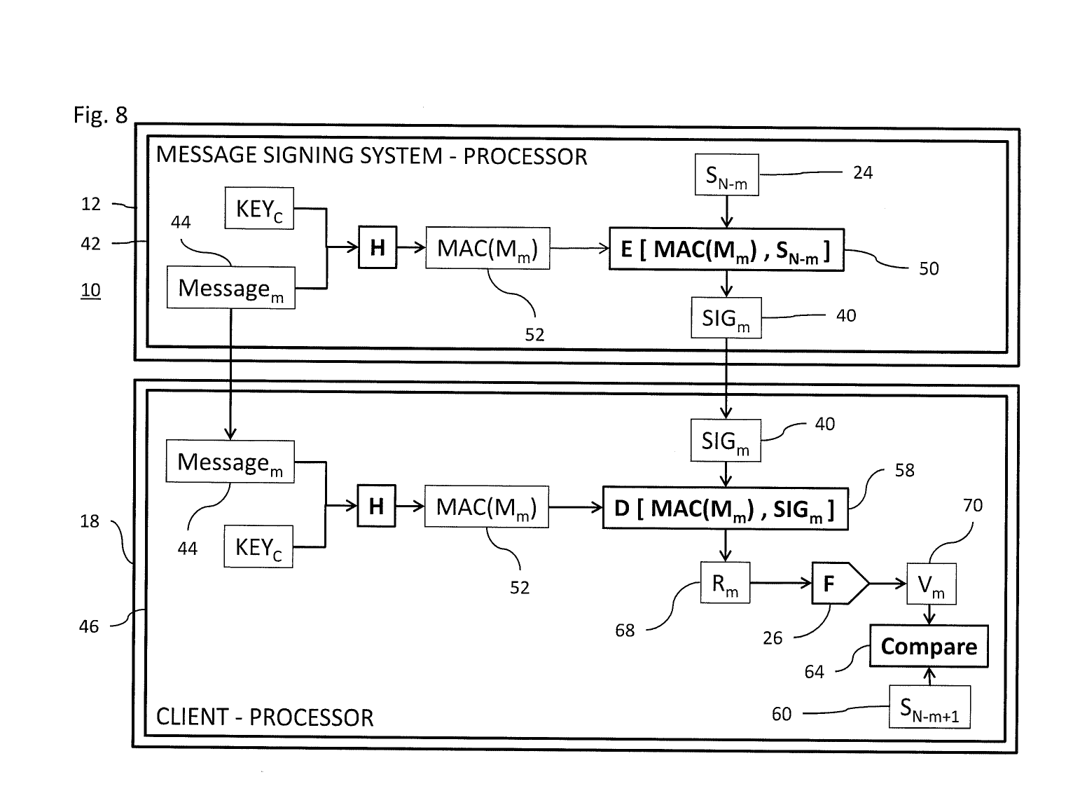

Reference is now made to FIG. 8, which is a partly pictorial, partly block diagram view of preparation and authentication of yet another signature 40 in the system 10 of FIG. 1.

FIG. 8 describes in general how an m^{th} message 44 (Messageₘ) may be signed by the message signing system 12 and authenticated by the client device 18, m being any value from 1 to N.

The processor 42 of the message signing system 12 is operative such that the creation of the digital signature 40 (SIGₘ) for the m^{th} message 44 includes the processor 42 evaluating the encryption function E (block 50) with S_{N-m} and the MAC (block 52) of the m^{th} message 44 as input.

The creation of signature 40 (Sigₘ) may be expressed mathematically as follows:

SIGₘ=E(MAC(Mₘ), S_{N-m}).

The processor 46 of the client device 18 is typically operative to receive the m^{th} message 44 and the digital signature 40 (SIGₘ) signing the m^{th} message 44 and authenticate the m^{th} message 44 against the digital signature 40 (SIGₘ).

The authentication typically includes: (a) evaluating the decryption function D (block 58) with the m^{th} digital signature 40 and the MAC (block 52) of the m^{th} message 44 as input to the decryption function D (block 58) yielding an m^{th} result (block 68); (b) applying the one-way function F ((block 26) to the m^{th} result (block 68) yielding an m^{th} value (block 70); and (c) checking if the m^{th} value (block 70) is equal to the value S_{N-m+1} (block 60).

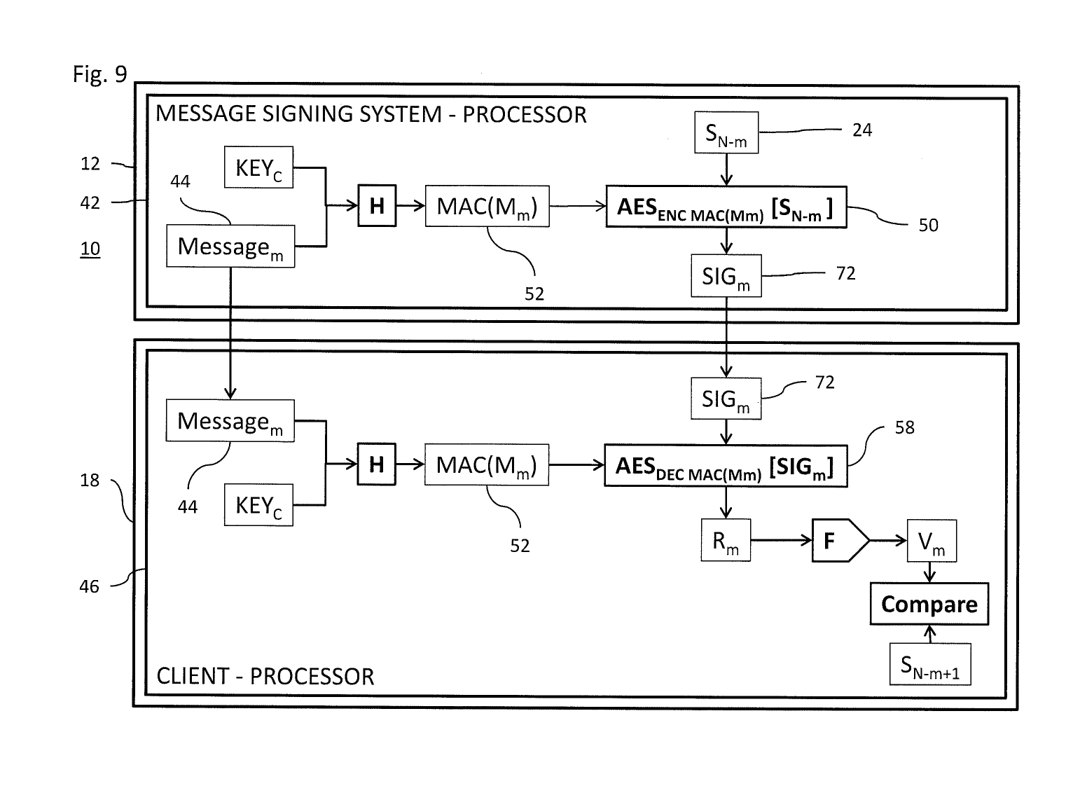

Reference is now made to FIG. 9, which is partly pictorial, partly block diagram view of preparation and authentication of the signature 40 using AES in the system 10 of FIG. 1.

The processor 42 of the message signing system 12 is operative such that evaluating the encryption function E (block 50) includes encrypting S_{N-m} (block 24) with an encryption key based on the MAC (block 52) of the m^{th} message 44.

The processor 46 of the client device 18 is operative such that evaluating the decryption function D (block 58) includes decrypting the signature 40 with a decryption key based on the MAC (block 52) of the m^{th} message 44.

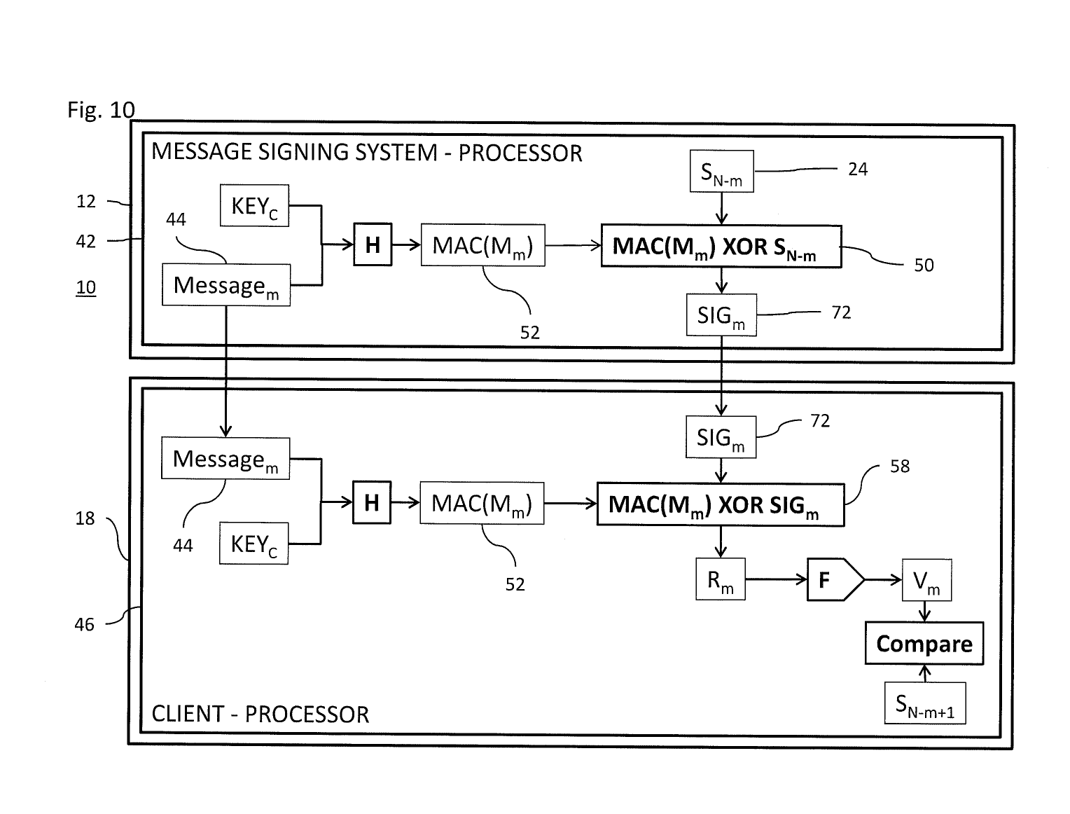

Reference is now made to FIG. 10, which is partly pictorial, partly block diagram view of preparation and authentication of the signature 40 using XOR in the system 10 of FIG. 1.

The processor 42 of the message signing system 12 is operative such that evaluating the encryption function E (block 50) includes evaluating S_{N-m} (block 24) XOR the MAC (block 52) of the m^{th} message 44.

The processor 46 of the client device 18 is operative such that evaluating the decryption function D (block 58) includes evaluating the signature 40 XOR the MAC (block 52) of the m^{th} message 44.

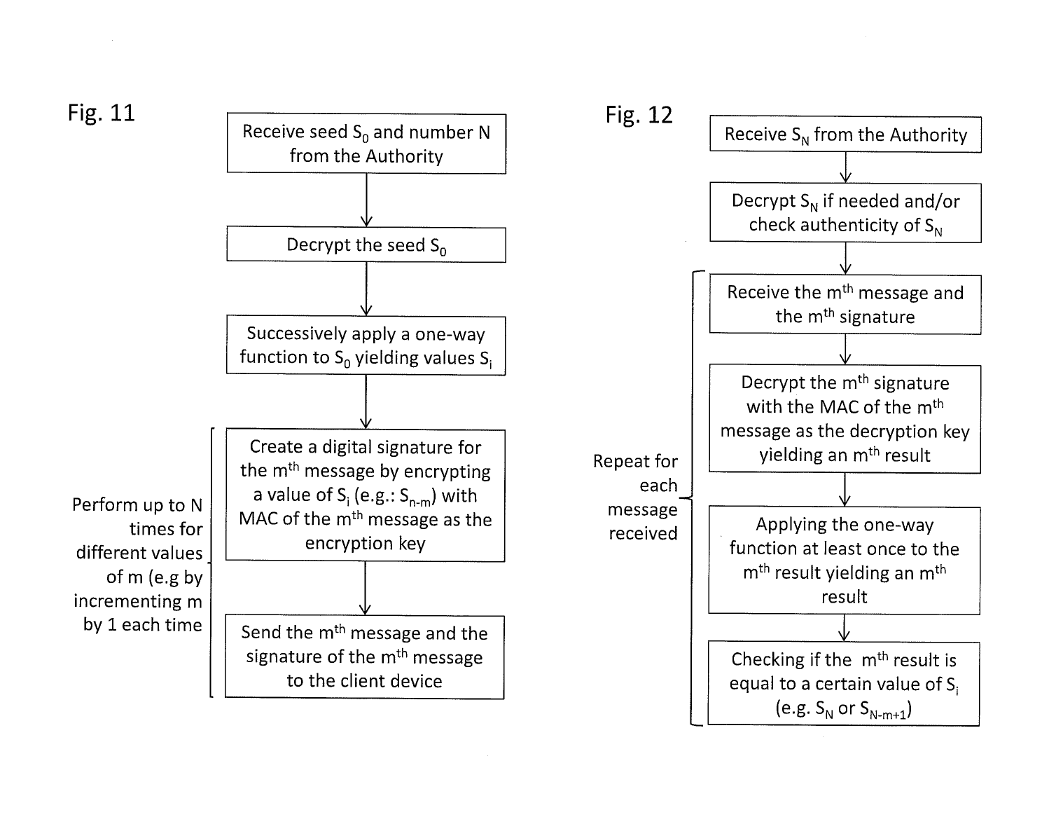

Reference is now made to FIG. 11, which is a flow chart showing steps included in the preparation of signatures in the system 10 of FIG. 1.

Reference is now made to FIG. 12, which is a flow chart showing steps included in the authentication of signatures in the system 10 of FIG. 1.

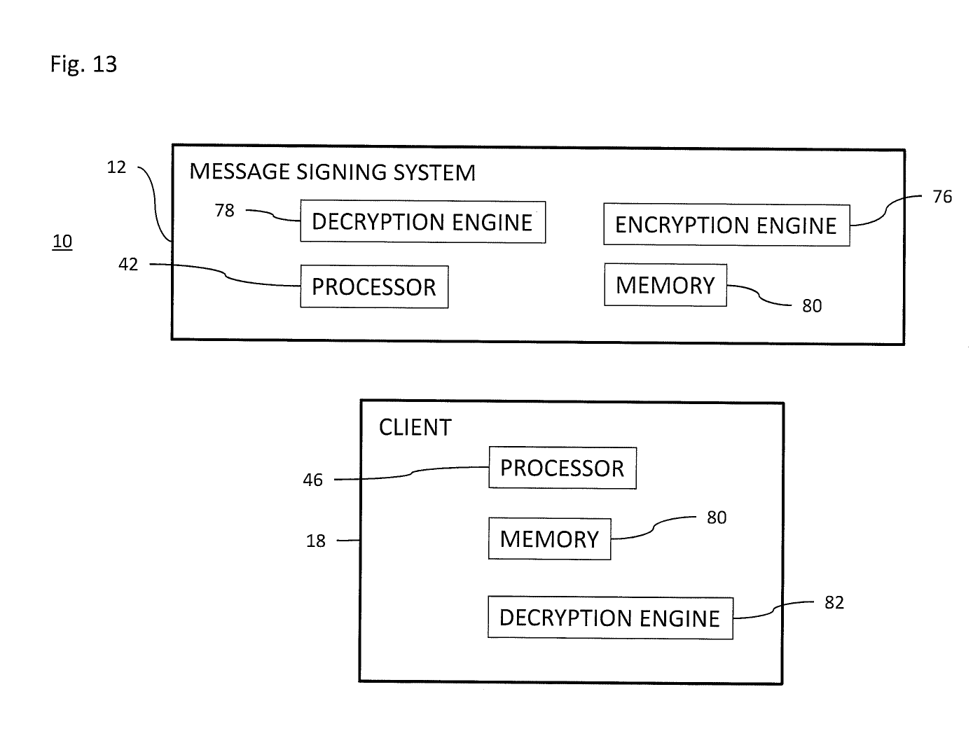

Reference is now made to FIG. 13, which is a block diagram of the message signing system 12 and one of the client devices 18 in the system 10 of FIG. 1.

The message signing system 12 also includes a memory 74 and optionally an encryption engine 76 and optionally a decryption engine 78. The memory 74 is operative to store data used by the processor 42 such as computer code and variables and other data used during execution of the computer code. If the processor 42 does not perform encryption and/or decryption functions, these functions may be performed by the encryption engine 76 and the decryption engine 78.

The client device 18 also includes a memory 80 and optionally a decryption engine 82. The memory 80 is operative to store data used by the processor 46 such as computer code and variables and other data used during execution of the computer code. If the processor 46 does not perform decryption functions, these functions may be performed by the decryption engine 82.

In practice, some or all of these functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to devices 12, 18 in electronic form, over a network, for example. Alternatively or additionally, the software may be stored in tangible, non-transitory computer-readable storage media, such as optical, magnetic, or electronic memory.

It is appreciated that software components of the present invention may, if desired, be implemented in ROM (read only memory) foam. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It will be appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

It will be appreciated by persons skilled in the art that the present invention is not limited by what has been particularly shown and described hereinabove. Rather the scope of the invention is defined by the appended claims and equivalents thereof.

What is claimed is:

1. A message signing system comprising:
a processor; and
a memory to store data used by the processor, wherein the processor is operative to:
receive a seed S₀ and a number N from an authority providing permission to digitally sign up to N messages for a client device, the seed S₀ being received from the authority in an encrypted format;
decrypt the seed S₀;
successively apply a one-way function to the seed S₀ yielding a chain having a plurality of values Sᵢ, i being greater than zero, S₁ being a result of applying the one-way function once to the seed S₀, the value Sᵢ being a result of successively applying the one-way function to the seed S₀) i times for values of i greater than 1;
create up to N digital signatures, creation of each of the digital signatures including evaluating an encryption function with one of the values Sᵢ and a MAC of one of the messages as input to the encryption function, the MAC being a keyed hash function, each of the created digital signatures being based on a different one of the values Sᵢ and a different one of the messages; and
send the created digital signatures and the messages signed by the created digital signatures to the client device.

2. The system according to claim 1, wherein the processor is operative such that the creation of one of the digital signatures for an m^{th} one of the messages includes the processor evaluating the encryption function with S_{N-m} and MAC of the m^{th} message as input.

3. The system according to claim 1, wherein the processor is operative such that the evaluating the encryption function includes evaluating Sᵢ XOR the MAC of the one message.

4. The system according to claim 1, wherein the processor is operative such that the evaluating the encryption function includes encrypting Sᵢ with an encryption key based on the MAC of the one message.

5. The system according to 1, wherein the processor is operative:
to successively send the created digital signatures; and
such that successively sent ones of the digital signatures are based on the values of the chain which are successively closer to the seed S₀.

6. A client device comprising:
a processor; and
a memory to store data used by the processor, wherein the processor is operative to:
receive a security field S_{N} from an authority, the security field S_{N} being signed and/or encrypted by the authority, the security field S_{N} resulting from successively applying a one-way function to a seed S₀ N times yielding a chain having a plurality of values Sᵢ including S_{N}, i being an integer from 1 to N inclusive;
decrypt the seed S_{N} if the seed S_{N} is received in an encrypted format from the authority;
receive up to N messages and up to N digital signatures from a message signing system, each one of the digital signatures signing a different one of the messages; and
authenticate a first one of the messages against a first one of the digital signatures signing the first message, the authentication including: evaluating a decryption function with the first digital signature and a MAC of the first message as input to the decryption function yielding a first result, the MAC being a keyed hash function; applying the one-way function to the first result, or successively applying the one-way function a number of times to the first result, yielding a first value; and
checking if the first value is equal to the security field S_{N}.

7. The device according to claim 6, wherein the processor is operative to:
receive a second one of the messages and a second one of the digital signatures signing the second message from the message signing system; and
authenticate the second message against the second digital signature including:
evaluating the decryption function with the second digital signature and the MAC of the second message as input to the decryption function yielding a second result; and
applying the one-way function to the second result, or successively applying the one-way function a number of times to the second result, yielding a second value.

8. The device according to claim 7, wherein the processor is operative to check that the second value is closer to the seed S₀ along the chain than the first value.

9. The device according to claim 7, wherein the processor is operative to check if the second value is equal to the first result as part of authenticating the second message against the second digital signature.

10. The device according to claim 9, wherein the first result is equal to S_{N-1} and the second result is equal to S_{N-2}.

11. The device according to claim 6, wherein the processor is operative to:
receive an m^{th} one of the messages and an m^{th} one of the digital signatures signing the m^{th} message from the message signing system; and
authenticate the m^{th} message against the m^{th} digital signature including:
evaluating the decryption function with the m^{th} digital signature and the MAC of the m^{th} message as input to the decryption function yielding an m^{th} result;
applying the one-way function to the m^{th} result yielding an m^{th} value; and
checking if the m^{th} value is equal to the value S_{N-m+1}.

12. The device according to claim 6, wherein the processor is operative such that evaluating the decryption function includes evaluating the first digital signature XOR the MAC of the first message.

13. The device according to claim 6, wherein the processor is operative such that evaluating the decryption function includes decrypting the first digital signature with a decryption key based on the MAC of the first message.

14. A message signing method comprising:
receiving a seed S₀ and a number N from an authority providing permission to digitally sign up to N messages for a client device, the seed S₀ being received from the authority in an encrypted format;
decrypting the seed S₀;
successively applying a one-way function to the seed S₀ yielding a chain having a plurality of values Sᵢ, i being greater than zero such that the value Sᵢ is a result of successively applying the one-way function to the seed S₀ i times;
creating up to N digital signatures, creation of each of the digital signatures including evaluating an encryption function with one of the values Sᵢ and a MAC of one of the messages as input to the encryption function, the MAC being a keyed hash function, each of the N digital signatures being based on a different one of the values Sᵢ and a different one of the messages; and
sending the created digital signatures and the messages signed by the created digital signatures to the client device.

15. A method comprising:
receiving a security field S_{N} from an authority, the security field S_{N} being signed and/or encrypted by the authority, the security field S_{N} resulting from successively applying a one-way function to a seed S₀ N times yielding a chain having a plurality of values Sᵢ including S_{N}, i being an integer from 1 to N;
decrypting the seed S_{N} if the seed S_{N} is received in an encrypted format from the authority;
receiving up to N messages and up to N digital signatures from a message signing system, each one of the digital signatures signing a different one of the messages;
authenticating a first one of the messages against a first one of the digital signatures signing the first message, the authenticating including:
evaluating a decryption function with the first digital signature and a MAC of the first message as input to the decryption function yielding a first result, the MAC being a keyed hash function;
applying the one-way function to the first result, or successively apply the one-way function a number of times to the first result, yielding a first value; and
checking if the first value is equal to the security field S_{N}.
